(19) United States
(12) Patent Application Publication
(10) Pub. No.: US 2017/0295556 A1
(43) Pub. Date: Oct. 12, 2017

(54) FORWARDING SIGNALING MESSAGES FROM TWO OR MORE COMMUNICATION NETWORKS ASSOCIATED WITH DIFFERENT RADIO ACCESS TECHNOLOGIES TO A USER EQUIPMENT

(71) Applicant: QUALCOMM Incorporated, San Diego, CA (US)

(72) Inventors: Parthasarathy KRISHNAMOORTHY, San Diego, CA (US); Kamalakar GANTI, San Diego, CA (US); Georgios TSIRTSIS, London (GB); Ammar KITABI, San Diego, CA (US); Pavan KAIVARAM, San Diego, CA (US); Jayesh BATHIJA, San Diego, CA (US); Praveen Kumar APPANI, San Diego, CA (US); Vidya Sagar PUTTA, San Diego, CA (US)

(21) Appl. No.: 15/095,966

(22) Filed: Apr. 11, 2016

(51) Int. Cl. H04W 60/00; H04W 68/00; H04W 4/12

(52) U.S. Cl. CPC H04W 60/005; H04W 4/12; H04W 68/005; H04W 88/184

(57) ABSTRACT

A UE registers with a paging hub to a message forwarding service that is configured to forward information from messages wirelessly transmitted by two or more RANs associated with different RAT-types to the UE over a local wireless network that is separate from the two or more RANs. The UE refrains from monitoring a set of downlink wireless channels used by the two or more RANs while the paging hub monitors the set of downlink wireless channels on behalf of the UE. The paging hub detects a signaling message that is targeted to the UE by a given RAN, and forwards a message including information derived from the signaling message to the local wireless network for transmission to the UE. The UE receives the forwarded message and selectively communicates with the given RAN in response to the received message.

### BACKGROUND

### 1. Field of the Disclosure

This disclosure relates to forwarding signaling messages from two or more communication networks associated with different radio access technologies (RATs) to a user equipment (UE).

### 2. Description of the Related Art

Wireless communication systems permit user equipments (UEs) to connect to an access network in accordance with a particular radio access technology (RAT). Examples of cellular RATs include 1× (or 1×RTT) CDMA2000, Global System for Mobile Communications (GSM), Wideband Code Division Multiple Access (W-CDMA), Universal Mobile Telecommunications System (UMTS) and Long-Term Evolution (LTE) (e.g., LTE 4G, LTE 5G, etc.). Non-cellular RATs generally include short-range wireless technologies, such as Bluetooth, WiFi (or IEEE 802.11) or device-to-device (D2D) (e.g., WiFi-Direct, LTE-Direct, etc.).

Some modern UEs are configured to camp upon multiple RATs at the same time. When a UE is camped on multiple RATs (e.g., 1× and LTE), the UE performs page monitoring and channel maintenance across each of the multiple RATs. These periodic wakeups across different RATs increase power consumption and/or decrease battery life on the UE. These periodic wakeups may occur even if the UE is connected to an alternative non-cellular RAT (e.g., a WiFi network) for data connectivity.

UEs may remain in idle mode for significant durations (e.g., 80% of the time over the course of a day), and periodic wakeups across each RAT that the UE is camped upon can contribute to battery drain on the UEs. For example, some RATs (e.g., GSM, W-CDMA, etc.) follow short DRX or paging cycles (e.g., 470 ms, 640 ms, etc.), which causes UEs to wake up relatively frequently to monitor for signaling messages (e.g., paging messages, overhead messages, etc.), even when the UEs are idle.

In addition to power consumption, link quality can be a factor affecting overall performance. In particular, when UEs are located indoors, various factors can cause signal degradation from cellular signals. These factors can range from building materials (e.g., concrete and tinted glass, etc.), and building locations. Further, UEs configured to camp upon multiple RATs are deployed with multi-RAT modems provisioned with a single transceiver. In this case, the UEs can only tune to one particular RAT at a particular instant, which creates the possibility for a signal collision.

### SUMMARY

An example relates to a method of operating a paging hub. The paging hub may register a user equipment (UE) to a message forwarding service that is configured to forward information from messages wirelessly transmitted by two or more radio access networks (RANs) associated with different radio access technology (RAT)-types to the UE over a local wireless network that is separate from the two or more RANs. The paging hub may monitor a set of downlink wireless channels used by the two or more RANs. The paging hub may detect a signaling message that is transmitted over a given downlink wireless channel from the set of downlink wireless channels that is targeted to the UE. The paging hub may forward a message including information derived from the signaling message to the local wireless network for transmission to the UE.

Another example relates to a method of operating a UE. The UE may register, with a paging hub, to a message forwarding service that is configured to forward information from messages wirelessly transmitted by two or more RANs associated with different RAT-types to the UE over a local wireless network that is separate from the two or more RANs. The UE may refrain from monitoring a set of downlink wireless channels used by the two or more RANs. The UE may receive, from the paging hub via the local wireless network, a message that is directed to the UE and which includes information derived from a signaling message that originated as a wireless transmission from a given RAN among the two or more RANs on a given downlink wireless channel among the set of downlink wireless channels. The UE may selectively communicate with the given RAN in response to the received message.

Another example relates to a paging hub. The paging hub may include a processor, memory, and transceiver circuitry configured to register a UE to a message forwarding service that is configured to forward information from messages wirelessly transmitted by two or more RANs associated with different RAT-types to the UE over a local wireless network that is separate from the two or more RANs, monitor a set of downlink wireless channels used by the two or more RANs, detect a signaling message that is transmitted over a given downlink wireless channel from the set of downlink wireless channels that is targeted to the UE, and forward a message including information derived from the signaling message to the local wireless network for transmission to the UE.

Another example relates to a UE. The UE may include a processor, memory, and transceiver circuitry configured to register, with a paging hub, to a message forwarding service that is configured to forward information from messages wirelessly transmitted by two or more RANs associated with different RAT-types to the UE over a local wireless network that is separate from the two or more RANs, refrain from monitoring a set of downlink wireless channels used by the two or more RANs, receive, from the paging hub via the local wireless network, a message that is directed to the UE and which includes information derived from a signaling message that originated as a wireless transmission from a given RAN among the two or more RANs on a given downlink wireless channel among the set of downlink wireless channels, and selectively communicate with the given RAN in response to the received message.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communications device that includes structure configured to perform functionality in accordance with an embodiment of the disclosure.

FIG. 4 illustrates a paging hub in accordance with an embodiment of the disclosure.

FIG. 5A illustrates the paging hub of FIG. 4 being deployed within a communications network in accordance with an embodiment of the disclosure.

FIG. 5B illustrates a more detailed example implementation of a connection between the paging hub of FIG. 4 and a UE in accordance with an embodiment of the disclosure.

FIG. 5C illustrates a more detailed example implementation of the connection between the paging hub of FIG. 4 and a UE in accordance with another embodiment of the disclosure.

FIG. 6 illustrates the paging hub of FIG. 4 being deployed within a particular communications network in accordance with an embodiment of the disclosure.

FIG. 7 illustrates operation of the paging hub of FIG. 4 in accordance with an embodiment of the disclosure.

FIG. 8 illustrates operation of a UE in accordance with an embodiment of the disclosure.

FIG. 9 illustrates example implementations of the processes of FIGS. 8 and 9 in accordance with an embodiment of the disclosure.

FIG. 10 illustrates a continuation of the process of FIG. 9 in accordance with an embodiment of the disclosure.

FIG. 11 illustrates a continuation of the process of FIG. 9 in accordance with another embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage, or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile device”, a “mobile terminal”, a “mobile station” and variations thereof. In an embodiment, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

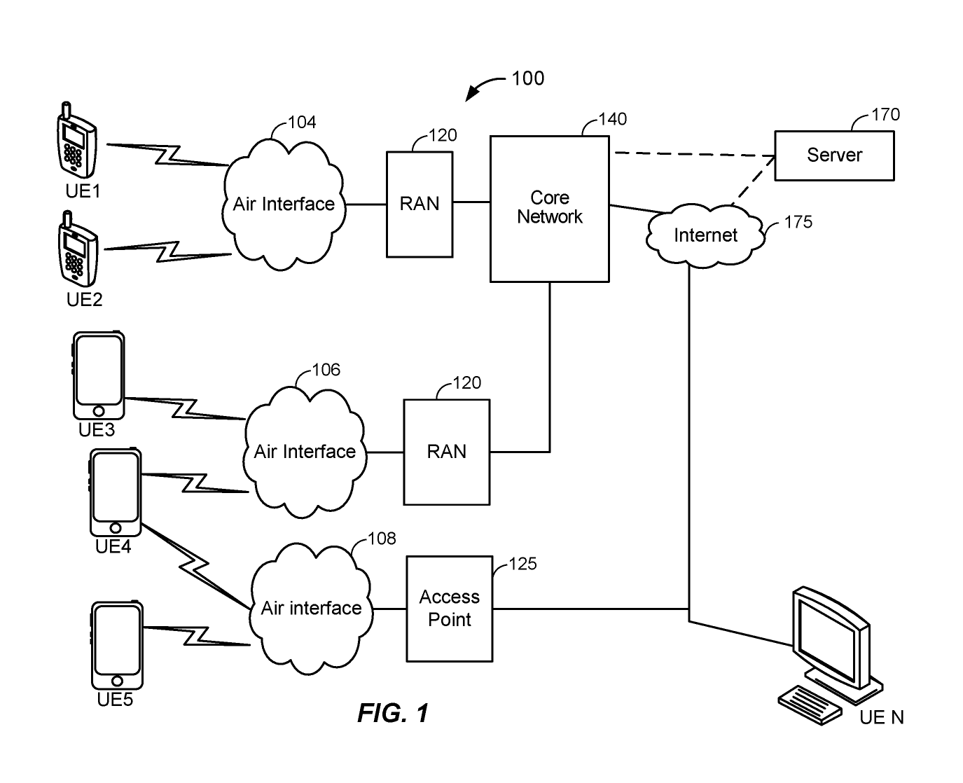

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175.

The Internet 175, in some examples includes a number of routing agents and processing agents (not shown in FIG. 1 for the sake of convenience). In FIG. 1, UE N is shown as connecting to the Internet 175 directly (i.e., separate from the core network 140, such as over an Ethernet connection or WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs 1 . . . N.

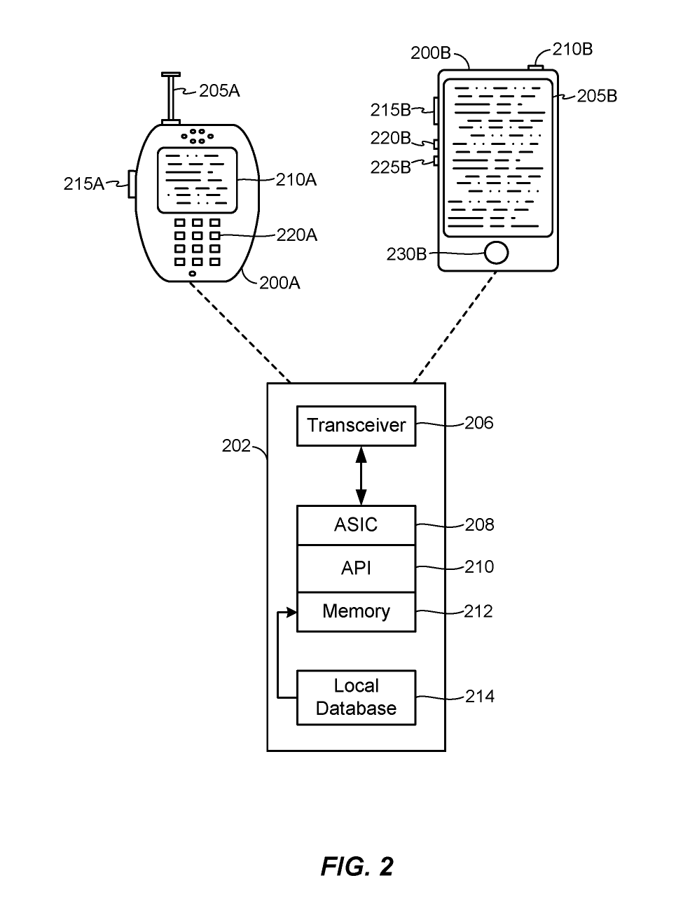

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, a display 210A, at least one button 215A (e.g., a PTT button, a power button, a volume control button, etc.), and a keypad 220A among other components, as is known in the art. Also, an external casing of the UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of the UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., the server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes an application programming interface (API) 210 layer that interfaces with any resident programs in a memory 212 of UEs 200A and 200B. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UEs 200A and 200B, etc.) including the ability to perform the functions described herein. As will be appreciated by those skilled in the art, the various logic elements can be embodied in discrete elements, software modules executed on a processor, or any combination of software and hardware to achieve the functionality disclosed herein. For example, the ASIC 208, the memory 212, the API 210 and the local database 214 may all be used cooperatively to load, store, and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative, and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to UEs 200A and/or 200B from the RAN 120 using a variety of networks and configurations. Accordingly, the illustrations provided herein are not intended to limit the embodiments of the disclosure and are merely to aid in the description of aspects of embodiments of the disclosure.

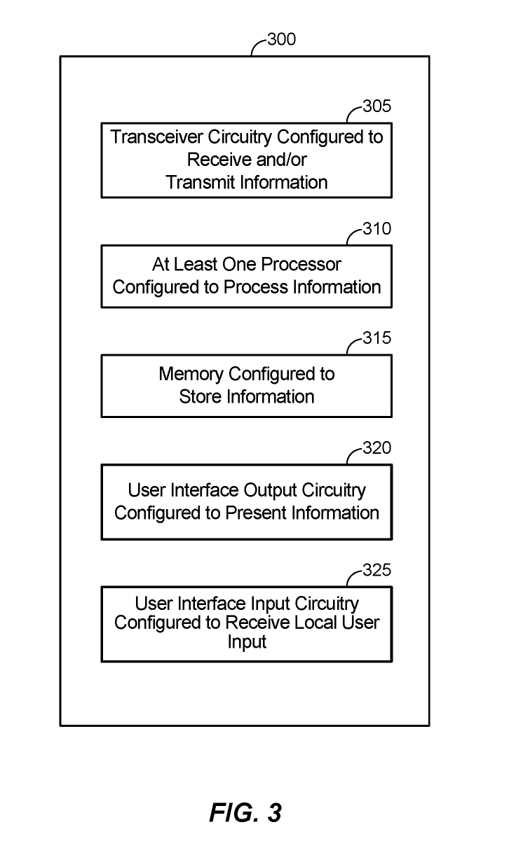

FIG. 3 illustrates a communications device 300 that includes structural components in accordance with an embodiment of the disclosure. The communications device 300 can correspond to any of the above-noted communications devices, including but not limited to UEs 1 . . . N, UEs 200A and 200B, any component included in the RAN 120 such as base stations, access points or eNodeBs, any component of the core network 140, any components coupled to the Internet 175 (e.g., the server 170), and so on. Thus, the communications device 300 can correspond to any electronic device that is configured to communicate with (or facilitate communication with) one or more other entities over the wireless communications system 100 of FIG. 1.

Referring to FIG. 3, the communications device 300 includes transceiver circuitry configured to receive and/or transmit information 305. In an example, if the communications device 300 corresponds to a wireless communications device (e.g., UE 200A and/or UE 200B), the transceiver circuitry configured to receive and/or transmit information 305 can include a wireless communications interface (e.g., Bluetooth, WiFi, WiFi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 305 can correspond to a wired communications interface (e.g., a serial connection, a USB or Firewire connection, an Ethernet connection through which the Internet 175 can be accessed, etc.). Thus, if the communications device 300 corresponds to some type of network-based server (e.g., the server 170), the transceiver circuitry configured to receive and/or transmit information 305 can correspond to an Ethernet card, in an example, that connects the network-based server to other communication entities via an Ethernet protocol. In a further example, the transceiver circuitry configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The transceiver circuitry configured to receive and/or transmit information 305 can also include software that, when executed, permits the associated hardware of the transceiver circuitry configured to receive and/or transmit information 305 to perform its reception and/or transmission function(s). However, the transceiver circuitry configured to receive and/or transmit information 305 does not correspond to software alone, and the transceiver circuitry configured to receive and/or transmit information 305 relies at least in part upon structural hardware to achieve its functionality. Moreover, the transceiver circuitry configured to receive and/or transmit information 305 may be implicated by language other than “receive” and “transmit”, so long as the underlying function corresponds to a receive and/or transmit function. For example, functions such as obtaining, acquiring, retrieving, measuring, etc., may be performed by the transceiver circuitry configured to receive and/or transmit information 305 in certain contexts as being specific types of receive functions. In another example, functions such as sending, delivering, conveying, forwarding, etc., may be performed by the transceiver circuitry configured to receive and/or transmit information 305 in certain contexts as being specific types of transmit functions. Other functions that correspond to other types of receive and/or transmit functions may also be performed by the transceiver circuitry configured to receive and/or transmit information 305.

Referring to FIG. 3, the communications device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform its processing function(s). However, the at least one processor configured to process information 310 does not correspond to software alone, and the at least one processor configured to process information 310 relies at least in part upon structural hardware to achieve its functionality. Moreover, the at least one processor configured to process information 310 may be implicated by language other than “processing”, so long as the underlying function corresponds to a processing function. For example, functions such as evaluating, determining, calculating, identifying, etc., may be performed by the at least one processor configured to process information 310 in certain contexts as being specific types of processing functions. Other functions that correspond to other types of processing functions may also be performed by the at least one processor configured to process information 310.

Referring to FIG. 3, the communications device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform its storage function(s). However, the memory configured to store information 315 does not correspond to software alone, and the memory configured to store information 315 relies at least in part upon structural hardware to achieve its functionality. Moreover, the memory configured to store information 315 may be implicated by language other than “storing”, so long as the underlying function corresponds to a storing function. For an example, functions such as caching, maintaining, etc., may be performed by the memory configured to store information 315 in certain contexts as being specific types of storing functions. Other functions that correspond to other types of storing functions may also be performed by the memory configured to store information 315.

Referring to FIG. 3, the communications device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to the UE 200A and/or UE 200B as shown in FIG. 2, the user interface output circuitry configured to present information 320 can include the display 210A and/or 205B. In a further example, the user interface output circuitry configured to present information 320 can be omitted for certain communications devices, such as network communications devices that do not have a local user (e.g., network switches or routers, remote servers, etc.). The user interface output circuitry configured to present information 320 can also include software that, when executed, permits the associated hardware of the user interface output circuitry configured to present information 320 to perform its presentation function(s). However, the user interface output circuitry configured to present information 320 does not correspond to software alone, and the user interface output circuitry configured to present information 320 relies at least in part upon structural hardware to achieve its functionality. Moreover, the user interface output circuitry configured to present information 320 may be implicated by language other than “presenting”, so long as the underlying function corresponds to a presenting function. For example, functions such as displaying, outputting, prompting, conveying, etc., may be performed by the user interface output circuitry configured to present information 320 in certain contexts as being specific types of presenting functions. Other functions that correspond to other types of storing functions may also be performed by the user interface output circuitry configured to present information 320.

Referring to FIG. 3, the communications device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A and/or UE 200B as shown in FIG. 2, the user interface input circuitry configured to receive local user input 325 can include the buttons 215A, 210B, 215B, 225B and/or 230B 220A, the display 205B (if a touchscreen), etc. In a further example, the user interface input circuitry configured to receive local user input 325 can be omitted for certain communications devices, such as network communications devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform its input reception function(s). However, the user interface input circuitry configured to receive local user input 325 does not correspond to software alone, and the user interface input circuitry configured to receive local user input 325 relies at least in part upon structural hardware to achieve its functionality. Moreover, the user interface input circuitry configured to receive local user input 325 may be implicated by language other than “receiving local user input”, so long as the underlying function corresponds to a receiving local user function. For example, functions such as obtaining, receiving, collecting, etc., may be performed by the user interface input circuitry configured to receive local user input 325 in certain contexts as being specific types of receiving local user functions. Other functions that correspond to other types of receiving local user input functions may also be performed by the user interface input circuitry configured to receive local user input 325.

Referring to FIG. 3, while the configured structural components of 305 through 325 are shown as separate or distinct blocks in FIG. 3 that are implicitly coupled to each other via an associated communication bus (not shown expressly), it will be appreciated that the hardware and/or software by which the respective configured structural components of 305 through 325 performs their respective functionality can overlap in part. For example, any software used to facilitate the functionality of the configured structural components of 305 through 325 can be stored in the non-transitory memory associated with the memory configured to store information 315, such that the configured structural components of 305 through 325 each performs their respective functionality (i.e., in this case, software execution) based in part upon the operation of software stored by the memory configured to store information 315. Likewise, hardware that is directly associated with one of the configured structural components of 305 through 325 can be borrowed or used by other configured structural components of 305 through 325 from time to time. For example, the at least one processor configured to process information 310 can format data into an appropriate format before being transmitted by the transceiver circuitry configured to receive and/or transmit information 305, such that the transceiver circuitry configured to receive and/or transmit information 305 performs its functionality (i.e., in this case, transmission of data) based in part upon the operation of structural hardware associated with the at least one processor configured to process information 310.

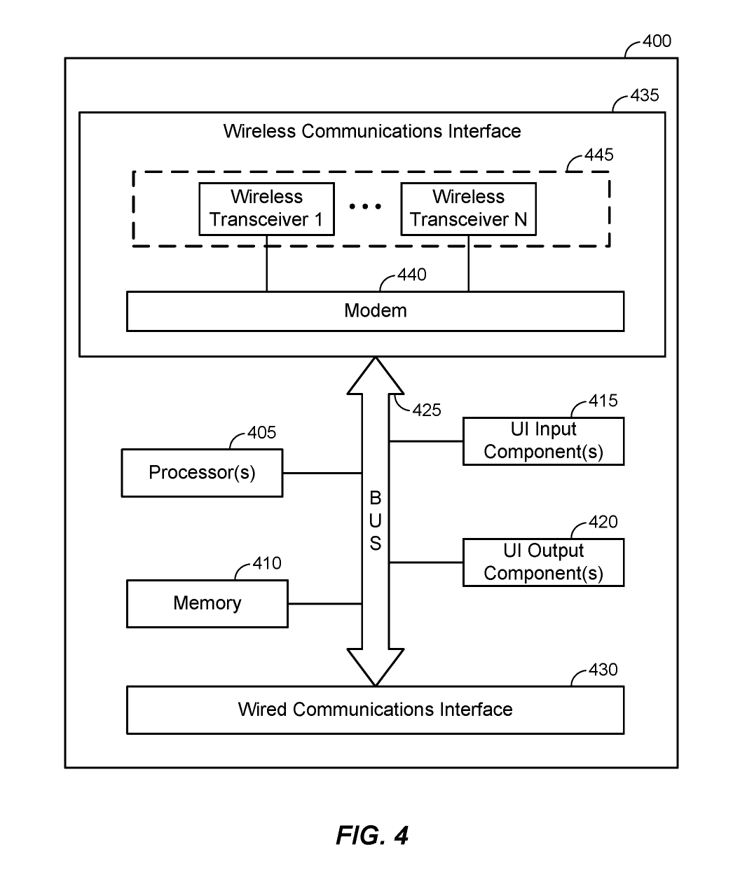

FIG. 4 illustrates a paging hub 400 in accordance with an embodiment of the disclosure. The paging hub 400 includes one or more processors 405 and a memory 410. The paging hub 400 may also optionally include one or more UI input components 415 and/or one or more UI output components 420. The UI input and output components 415 and 420 are optional because, in at least one embodiment, the paging hub 400 may be implemented as a network device that is remotely accessed by an administrator without direct user interaction. The various components depicted in the paging hub 400 may communicate with each other via a bus 425.

The paging hub 400 further includes a wired communications interface 430 and a wireless communications interface 435. In an example embodiment, the wired communications interface 430 can be used to connect to a wired access network that can in turn be used to connect to a local wireless network to which a target UE is connected. The wireless communications interface 435 includes a modem 440 coupled to a set of wireless transceivers 445, which are denoted as wireless transceivers 1 . . . N in FIG. 4. The set of wireless transceivers 445 can be used to monitor multiple RANs with different RAT-types (e.g., 1×, W-CDMA, GSM, LTE, etc.). While referred to as a “paging” hub, the paging hub 400 may forward any type of signaling message, including but not limited to paging messages, SIB overhead messages and/or other types of overhead messages.

In at least one embodiment, the modem 440 is implemented as an always-on modem with the paging hub 400 being equipped with a power-line power supply (not shown) so that operation of the paging hub 400 need not be limited by battery power constraints. In one example implementation, the modem 440 can tune the set of wireless transceivers 445 to monitor transmissions of certain signaling channel(s) of multiple RANs with different RAT-types so as to detect pages and/or system information (termed as “Rx only or Idle mode activities”) that are transmitted over the monitored signaling channel(s). For example, on a RAN with a given RAT-type (e.g., 1× or W-CDMA), all pages on a given sector are broadcasted and the modem 440 can tune to the RAN to acquire all the broadcasted pages, as the modem 440 will receive the entire 1.23 MHz or 5 MHz RF cellular signal.

In terms of physical location, the paging hub 400 can be deployed at any point inside a coverage area of at least one base station for each target RAN that the paging hub 400 intends to monitor. Testing may optionally be performed to determine an optimal location at which to deploy the paging hub 400 to meet one or more criteria (e.g., a location at which each target RAN satisfies a threshold level of average link quality, a location at which the target RANs average a highest level of average link quality, etc.).

The paging hub 400 of FIG. 4 is one example implementation of the communications device 300 described above with respect to FIG. 3. In one particular embodiment, the wired and wireless communications interfaces 430 and 435 correspond to the transceiver circuitry configured to receive and/or transmit information 305 of FIG. 3, the memory 410 corresponds to the memory configured to store information 315 of FIG. 3, the UI input component(s) 415 correspond to the user interface input circuitry configured to receive local user input 325 of FIG. 3 and the UI output component(s) 410 correspond to the user interface output circuitry configured to present information 320 of FIG. 3.

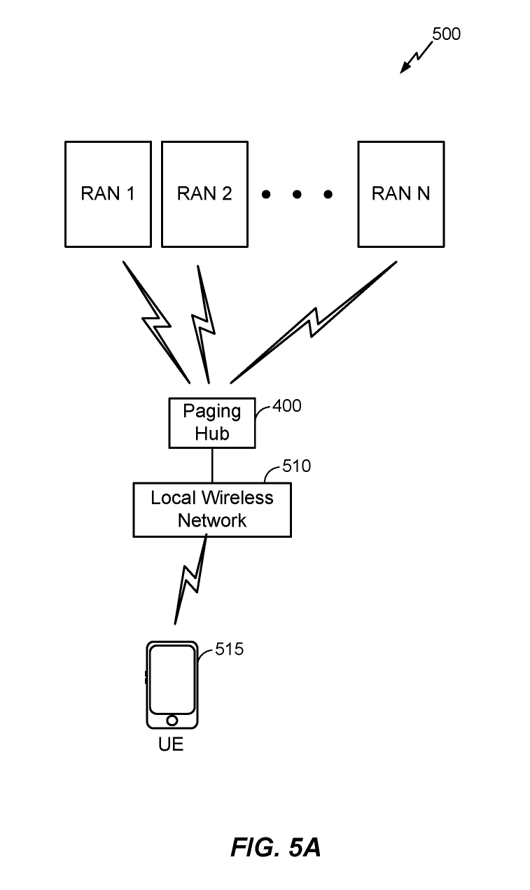

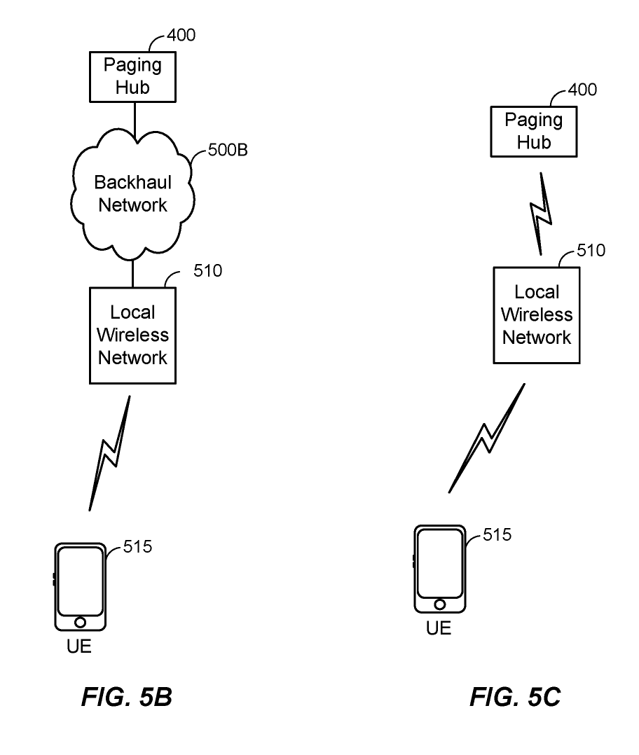

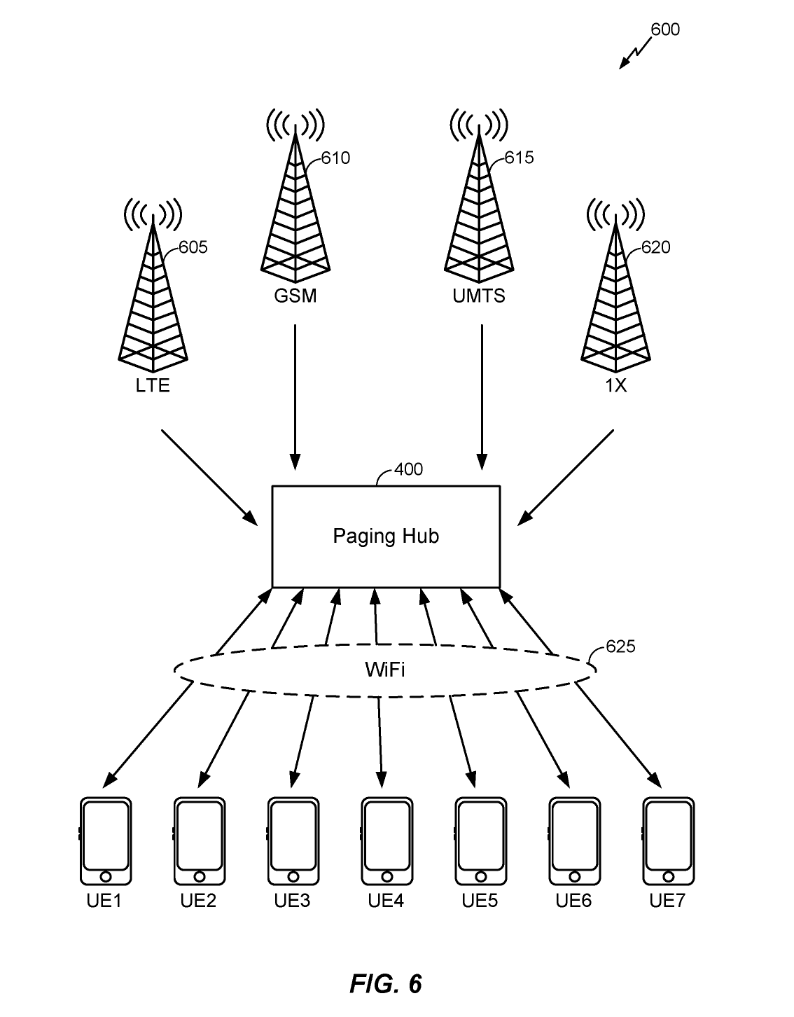

FIG. 5A illustrates the paging hub 400 being deployed within a communications network 500 in accordance with an embodiment of the disclosure. In the communications network 500, the paging hub 400 is deployed in coverage areas for each of RANs 1 . . . N, whereby RANs 1 . . . N are each associated with a different RAN-type. The paging hub 400 is configured to monitor one or more downlink wireless channels from each of RANs 1 . . . N via the wireless communications interface 435 of FIG. 4. The paging hub 400 is connected to UE 515 via a local wireless network 510 to which UE 515 is connected.

FIG. 5B illustrates a more detailed example implementation of the connection between the paging hub 400 and UE 515 in accordance with an embodiment of the disclosure. In FIG. 5B, the paging hub 400 is connected to a backhaul network 500B that is in turn connected to the local wireless network 510 (e.g., a WiFi network, a device-to-device (D2D) cluster that is connected to the backhaul network 500B via an external connection, etc.) to which UE 515 is connected. For example, the paging hub 400 can connect to the backhaul network 500B via the wired communications interface 430 (e.g., an Ethernet connection, etc.). In an alternative embodiment, the paging hub 400 can use a wireless communications scheme (e.g., WiFi, etc.) to connect to the backhaul network 500B. Accordingly, the paging hub 400 may be remote from the local wireless network 510 and UE 515 in at least one embodiment.

FIG. 5C illustrates a more detailed example implementation of the connection between the paging hub 400 and UE 515 in accordance with another embodiment of the disclosure. In FIG. 5C, the paging hub 400 is connected directly to the local wireless network 510 (e.g., a WiFi network, a D2D cluster, etc.) that is serving the UE 515. In the embodiment of FIG. 5C, the backhaul network 500B from FIG. 5B can be bypassed and the paging hub 400 and UE 515 can communicate over the local wireless network 510. While illustrated in FIG. 5C as a wireless connection, the paging hub 400 could alternatively be connected to the local wireless network 510 via a wired connection (e.g., a wired connection to an access point that provides service to UE 515, etc.).

With respect to FIG. 5C, in the embodiment where the local wireless network 510 corresponds to the D2D cluster, the paging hub 400 and the UE 515 may both be part of the local wireless network 510. The D2D cluster may be implemented as a single-hop D2D cluster or a multi-hop D2D cluster. If the D2D cluster is implemented as a multi-hop D2D cluster, the paging hub 400 and UE 515 may communicate via one or more hops to other D2D devices in the multi-hop D2D cluster (unless the paging hub 400 and UE 515 happen to be a single hop apart within the multi-hop D2D cluster, in which case a direct wireless connection is used for communication). While not illustrated expressly in FIG. 5C, if the D2D cluster is implemented as a single-hop D2D cluster, the paging hub 400 and UE 515 may communicate via a direct wireless connection (e.g., LTE-Direct, WiFi-Direct, etc.). In the case of a direct wireless connection, the operation whereby the paging hub 400 forwards data for transmission to UE 515 over the local wireless network 510 corresponds to the paging hub 400 performing a direct wireless transmission of the data to UE 515.

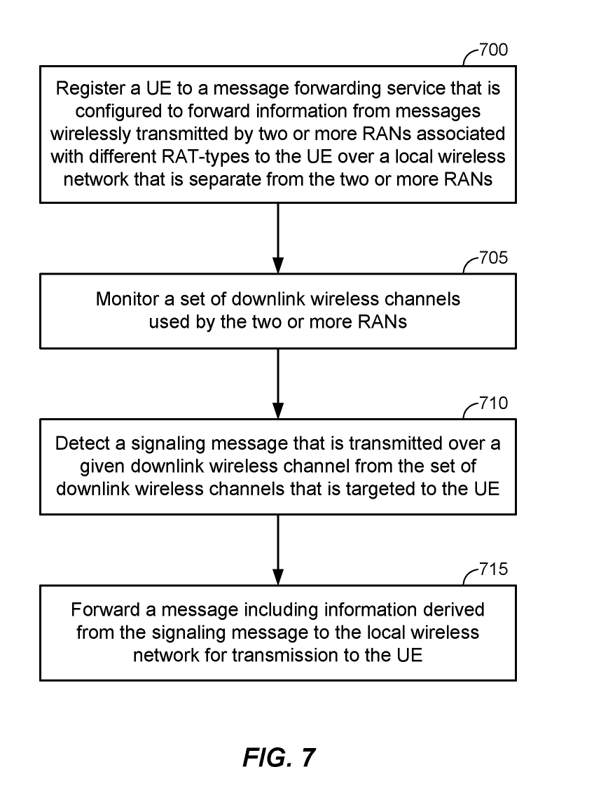

Below, reference is made to various communications that occur between the paging hub 400 and various UEs. It will be appreciated that any of these communications may be supported over any of the connection-types described with respect to FIGS. 5A-5C to facilitate the communicative functions described below with respect to FIGS. 7-11.

Referring to FIG. 5A, RANs 1 . . . N may correspond to a set of RAT-types that the paging hub 400 is configured to monitor on behalf of a set of UEs that are registered to the paging hub 400 in association with a message forwarding service. In at least one embodiment, it is possible that the paging hub 400 is inside of a coverage area of another RAN with a different RAT-type than any of RANs 1 . . . N, but the paging hub 400 does not monitor for this other RAN. In at least one embodiment, failure to monitor a particular RAN that is in-range of the paging hub 400 may result from an inability of the paging hub 400 to monitor the associated RAT-type of the non-monitored RAN. In an alternative embodiment, it is possible that no UEs from among a set of UEs registered to the paging hub 400 are interested in monitoring the particular RAN, so that the paging hub 400 intentionally refrains from monitoring the particular RAN based on the disinterest of the set of UEs.

As will be explained below in more detail with respect to FIGS. 7-11, the paging hub 400 may monitor downlink wireless channels from one or more of RANs 1 . . . N to detect (or intercept) one or more signaling messages that are targeted to UE 515, and then selectively forward the one or more signaling messages to UE 515 for transmission over the local wireless network 510. This permits UE 515 to monitor the local wireless network 510 to receive signaling messages from multiple RANs with different RAT-types to which UE 515 is a subscriber, so that UE 515 need not independently monitor each of the multiple RANs. Further, while FIG. 5A illustrates a single paging hub 400 installed in the communications network 500, in at least one embodiment, paging hubs similar to the paging hub 400 may be deployed throughout an entire wireless communications system (e.g., one per sector, etc.). Each deployed paging hub 400 may be responsible for monitoring respective RANs in a particular area (e.g., a sector).

FIG. 6 illustrates the paging hub 400 being deployed within a communications network 600 in accordance with an embodiment of the disclosure. The communications network 600 is a more detailed implementation of the communications network 500 described above with respect to FIG. 5A. In FIG. 6, the RAT-types of RANs 1 . . . N of FIG. 5A correspond to LTE 605, GSM 610, UMTS 615 and 1× 620, the local wireless network 510 of FIG. 5A corresponds to WiFi network 625 and UE 515 of FIG. 5A corresponds to any of UEs 1 . . . 7. Accordingly, the communications network 600 illustrates an example where there are four RANs (i.e., LTE 605, GSM 610, UMTS 615 and 1× 620) which use four separate RAT-types being monitored by the paging hub 400, and there are seven UEs (i.e., UEs 1 . . . 7 registered with the paging hub 400 for a message forwarding service with respect to some or all of these four RAT-types. In the embodiment of FIG. 6, the WiFi network 625 may correspond to an Intranet to which UEs 1 . . . 7 are each connected.

FIG. 7 illustrates operation of the paging hub 400 in accordance with an embodiment of the disclosure. At block 700, the paging hub 400 registers a UE (e.g., UE 515 of FIGS. 5A-5C, any of UEs 1 . . . 7 of FIG. 6, etc.) to a message forwarding service that is configured to forward information from messages wirelessly transmitted by two or more RANs associated with different RAT-types to the UE over a local wireless network (e.g., local wireless network 510 of FIG. 5, such as a WiFi network, a D2D cluster, etc.) that is separate from the two or more RANs.

In at least one embodiment, the registration that occurs at block 700 may initiate after the UE powers-up and performs initial acquisition of the two or more RANs, during which the UE is assigned a unique Temporary Mobile Subscriber Identity (TMSI) by each of the two or more RANs through which the two or more RANs identify the UE in downlink messaging (e.g., paging messages, etc.). The UE may convey its respective TMSIs and International Mobile Subscriber Identity (IMSI), and also Public Land Mobile Network (PLMN) details for the two or more RANs to the paging hub 400 via the UE's connection to the local wireless network 510. In a further embodiment, the UE may convey one or more group identifiers for one or more groups to which the UE belongs. The paging hub 400 determines whether the two or more RANs identified by the UE are supported for monitoring by the paging hub 400 (e.g., based on the PLMN details), after which the paging hub 400 completes registration of the UE to the message forwarding service for any RANs identified as being supported. Any RANs that are not identified as being supported by the paging hub 400 are not registered in association with the message forwarding service for the UE, and the paging hub 400 does not perform monitoring service for the identified, non-supported RANs. For convenience of explanation, the remainder of the process of FIG. 7 will be described under the assumption that each of the two or more RANs for which registration is requested is identified as supported.

At block 705 of FIG. 7, the paging hub 400 monitors a set of downlink wireless channels used by the two or more RANs. In one embodiment, the set of downlink wireless channels may include downlink signaling channels and/or paging channels used by the two or more RANs. For example, the set of downlink wireless channels monitored at block 705 may include downlink wireless channels upon which the two or more RANs transmit signaling messages to target UEs being operated in Rx-only mode or Idle mode, such as paging messages and System Information Block (SIB) overhead messages. During the monitoring that occurs at block 705, the paging hub 400 scans for any downlink messages that are targeted to the UE which was registered at block 700. The monitoring that occurs at block 705 can scan for downlink messages that are targeted to the UE in a variety of ways. In at least one embodiment, the paging hub 400 can scan for signaling messages that are individually targeted to the UE (e.g., targeted to one or the TMSIs and/or IMSI conveyed to the paging hub 400 at block 700). In another embodiment, the paging hub 400 can scan for signaling messages that are group-targeted to the UE (e.g., targeted to a group to which the UE belongs, which can be conveyed to the paging hub 400 during registration at block 700). In another embodiment, the paging hub 400 can scan for signaling messages corresponding to broadcast messages which are targeted to all in-range UEs.

At block 710 of FIG. 7, the paging hub 400 detects a signaling message that is transmitted over a given downlink wireless channel from the set of downlink wireless channels that is targeted (e.g., individually targeted, group targeted or broadcast) to the UE. In at least one embodiment, the detection at block 710 can occur by identifying that the signaling message is targeted to one of the assigned TMSIs and/or IMSI that is registered in association with the UE at block 700. In other embodiments, as noted above, the detection at block 710 can occur by identifying the signaling message as a broadcast message or identifying the signaling message as targeted to a group to which the UE belongs.

At block 715 of FIG. 7, the paging hub 400 forwards a message including information derived from the signaling message to the local wireless network 510 (e.g., via the backhaul network 500B) for transmission to the UE. In at least one embodiment, the paging hub 400 may evaluate one or more message forwarding rules (e.g., either manually configured by an operator of the UE or default message forwarding rules established at the paging hub 400) to selectively determine whether information for particular detected messages is to be forwarded to the UE. Further, in at least one embodiment, the information within the message that is forwarded to the UE at block 715 may be extracted from the signaling message (e.g., paging information, SIB information, other overhead information, etc.) and then added to a concatenated message that includes the UE's IMSI/TMSI, with the concatenated message being sent as the message to the local wireless network 510 for transmission to the UE in accordance with the UE's wakeup periodicity that is established between the UE and the local wireless network 510 (e.g., a WiFi wakeup periodicity, a D2D wakeup periodicity, etc.).

While the process of FIG. 7 is described with respect to a single UE, it will be appreciated that the paging hub 400 may perform the process of FIG. 7 with respect to one or more other UEs as well, such that the paging hub 400 may execute the message forwarding service on behalf of multiple UEs in parallel.

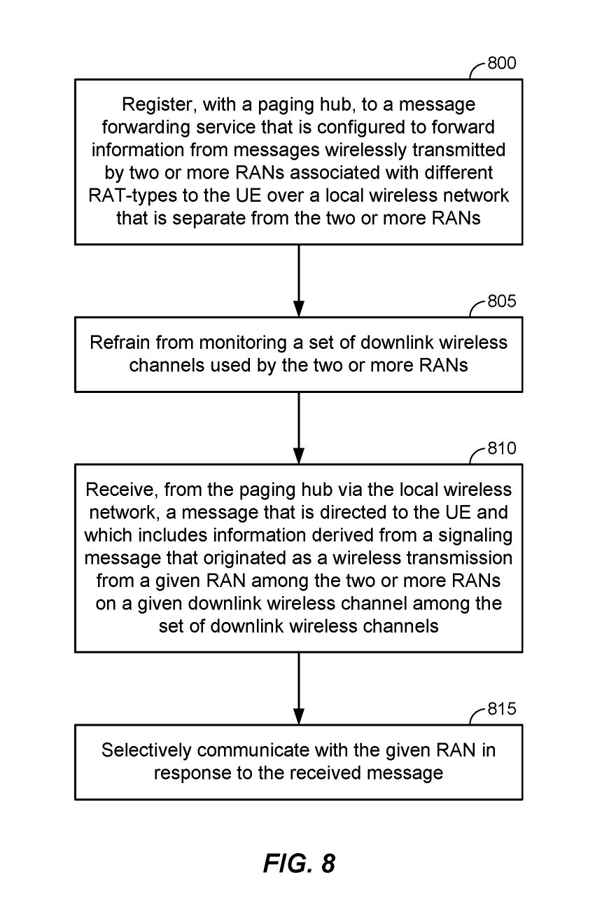

FIG. 8 illustrates operation of a UE (e.g., UE 515 of FIGS. 5A-5C, any of UEs 1 . . . 7 of FIG. 6, etc.) in accordance with an embodiment of the disclosure. At block 800, the UE registers, with a paging hub (e.g., paging hub 400 of FIG. 4), to a message forwarding service that is configured to forward information from messages wirelessly transmitted by two or more RANs associated with different RAT-types to the UE over a local wireless network (e.g., local wireless network 510 of FIG. 5A) that is separate from the two or more RANs. The registration that occurs at block 800 corresponds to the UE-side operation of the registration described above with respect to block 700 of FIG. 7 from the paging hub-side, and as such will not be described further for the sake of brevity.

At block 805, the UE refrains from monitoring a set of downlink wireless channels used by the two or more RANs. In at least one embodiment, the set of downlink wireless channels which the UE refrains from monitoring at block 805 may correspond to the same set of downlink wireless channels being monitored by the paging hub 400 at block 705 of FIG. 7. Accordingly, the paging hub 400 may monitor the set of downlink wireless channels on behalf of the UE, so the UE need not expend power and/or other resources attempting to monitor the two or more RANs with the different RAT-types.

At block 810, the UE receives, from the paging hub 400 via the local wireless network 510, a message that is directed to the UE and which includes information derived from a signaling message that originated as a wireless transmission from a given RAN among the two or more RANs on a given downlink wireless channel among the set of downlink wireless channels. In at least one embodiment, the message that is received at the UE at block 810 may correspond to the message that is forwarded by the paging hub 400 at block 715 of FIG. 7 (e.g., a concatenated message containing the IMSI/TMSI established during registration at block 800 plus information extracted from a signaling message detected at the paging hub 400). In at least one embodiment, the reception of the message at block 810 may occur in accordance with a wake-up periodicity at which the UE wakes up to monitor for downlink data from the local wireless network 510.

At block 815 of FIG. 8, the UE selectively communicates with the given RAN in response to the message received at block 810. In context with block 815, the UE communicating with the given RAN in a selective manner means that direct RAN communication with the UE is not necessarily triggered based on receipt of the message at block 815. Examples of UE actions that may be taken in response to receipt of the message at block 815 are provided below with respect to Table 1:

TABLE 1
Examples of Decision Logic Implemented at the UE for Responding to
Messages Forwarded to the UE by the Paging Hub 400

| | Signaling | | | |
|---|---|---|---|---|
| | Message type | RAN-type | UE State | Action Taken |
| 1 | Paging | LTE | Idle | Initiate communication |
| | message | | | with LTE network |
| | | | | to respond to |
| | | | | paging message |
| 2 | Paging | 1x | UE engaged in | Ignore paging message; |
| | message | | VoIP call | do not initiate |
| | | | | communication with |
| | | | | 1x network |
| 3 | SIB overhead | LTE | Idle | Update LTE |
| | message | | | communication |
| | | | | parameters based on |
| | | | | SIB overhead message, |
| | | | | if necessary; do not |
| | | | | initiate communication |
| | | | | with LTE network |
| 4 | Overhead | 1x | Idle | Update 1x system |
| | message | | | parameters based on the |
| | | | | newly received overhead |
| | | | | message (if any changes |
| | | | | in system parameters, UE |
| | | | | will get updated or will |
| | | | | skip the received |
| | | | | overhead messages) |

As shown above with respect to Table 1, the action taken by the UE at block 815 in response to the message received at block 810 can vary based upon a variety of factors, including but not limited to the type of the signaling message from which the information in the message received at block 815 is derived, the RAN-type, and the state of the UE. In Example #1 of Table 1, a paging message is received from an LTE network while the UE is idle, so the UE initiates communication with the LTE network to respond to the paging message. However, in Example #2 of Table 1, a paging message is received from a 1× network while the UE is already engaged in a VoIP call (e.g., via the local wireless network 510), so the UE continues the VoIP call without responding to the 1× paging message. The ignore-page decision in Example #2 of Table 1 may be based on 1× networks being allocated low-priority, the VoIP call being allocated a high-priority, or some combination thereof, whereby any of the relative priorities can be established by default or in accordance with user preference. In Example #3 of Table 1, a SIB overhead message (e.g., a broadcast message) is received from an LTE network while the UE is idle, and the UE updates one or more LTE communication parameters based on the SIB overhead message (if necessary), but there is no need for the UE to initiate communication with the LTE network so the UE does not do so. In Example #4 of Table 1, an overhead message (e.g., a broadcast message) is received from a 1× network while the UE is idle, and the UE updates one or more LTE communication parameters based on the 1× overhead message (if necessary), but similar to Example #3, there is no need for the UE to initiate communication with the 1× network so the UE does not do so.

While not shown expressly in FIG. 8, in at least one embodiment, if the UE initiates communication (e.g., a voice call, etc.) with the given RAN at 815, the UE can notify the paging hub 400 to discontinue the message forwarding service for the given RAN (e.g., the message forwarding service may remain active for other RAN(s) to which the UE is registered for the message forwarding service). When the UE eventually returns to idle mode (e.g., after termination of the voice call over the given RAN, etc.), the UE can notify the paging hub 400 to resume the message forwarding service for the given RAN.

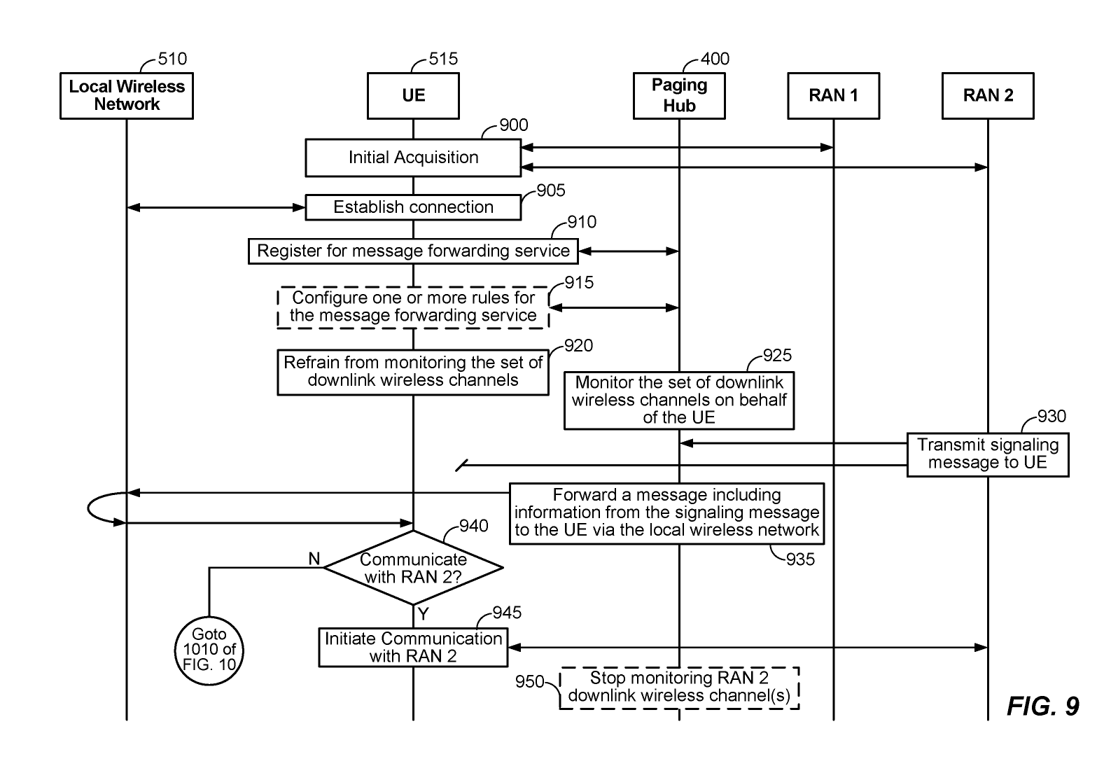

FIG. 9 illustrates example implementations of the processes of FIGS. 8 and 9 in accordance with an embodiment of the disclosure. At block 900, UE 515 powers-up and performs initial acquisition of RAN 1 and RAN 2, which are each associated with different RAT-types (e.g., 1×, W-CDMA, etc.). As described above, UE 515 may obtain unique TMSIs for each of RANs 1 and 2 as well as PLMN details during the initial acquisition at block 900. At block 905, UE 515 establishes a connection with the local wireless network 510. In an alternative embodiment, block 905 may occur before block 900 (e.g., if 900 occurs at some point after UE power-up). At block 910, UE 515 registers with the paging hub 400 for the message forwarding service with respect to RANs 1 and 2 (e.g., as in block 700 of FIG. 7 and/or 800 of FIG. 8). At block 915, UE 515 optionally establishes one or more message forwarding rules for the message forwarding service. In at least one embodiment, the message forwarding rules can relate to establishing priorities relative to particular message types (e.g., UE 515 wants all page messages forwarded from all RAT-types but does not care about overhead messages or particular types of overhead messages, etc.), can vary by RAT-type (e.g., forward paging messages from RANs 1 and 2 and forward SIB messages from RAN 2 only, etc.), can be based on information redundancy (e.g., if a new overhead message is received that contains the same or similar information to a previous overhead message whose information was already forwarded to UE 515, the new overhead message need not trigger message forwarding, etc.) and so on. Block 915 is optional in the sense that the paging hub 400 can use default message forwarding rules for the message forwarding service in the absence of any customization.

At block 920 of FIG. 9, UE 515 refrains from monitoring a set of downlink wireless channels used by RANs 1 and 2 (e.g., as in block 805 of FIG. 8), and at block 925, the paging hub 400 begins to monitor the set of downlink wireless channels used by the two or more RANs (e.g., as in block 705 of FIG. 7). At block 930, RAN 2 transmits a signaling message that is targeted (e.g., individually targeted, group targeted, or broadcast) to UE 515 on a given downlink wireless channel from the set of downlink wireless channels. Still referring to block 930, the signaling message fails to arrive at UE 515 because UE 515 is not monitoring the set of downlink wireless channels per block 920, but the signaling message is detected by the paging hub 400 based on the monitoring from block 925 (e.g., as in block 710 of FIG. 7).

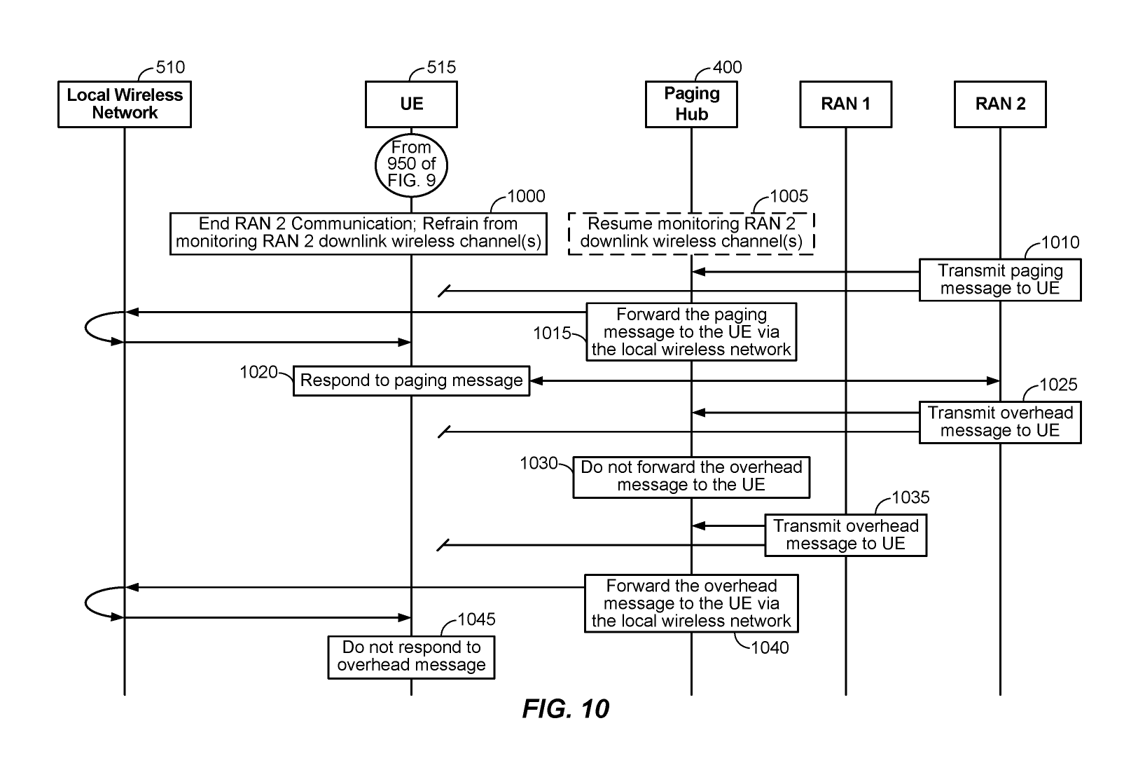

At block 935, the paging hub 400 forwards a message including information from the signaling message detected at block 930 to the local wireless network 510 (e.g., via the backhaul network 500B) for transmission to UE 515 (e.g., as in block 715 of FIG. 7), and the forwarded message is transmitted by the local wireless network 510 and received at UE 515 (e.g., as in block 810 of FIG. 8). At block 940, UE 515 determines whether the received message is sufficient to trigger initiation of communication with RAN 2 (i.e., the RAN from which the corresponding signaling message originated). In at least one embodiment, the determination at block 940 can be based on the factors discussed above with respect to Table 1. If UE 515 determines that the received message is sufficient to trigger initiation of communication with RAN 2 at block 940 (e.g., the received message at block 935 contains paging information, etc.), then the communication with RAN 2 is initiated at block 945 (e.g., a voice call, a data session, etc.). If UE 515 determines that the received message is not sufficient to trigger initiation of communication with RAN 2 at block 940 (e.g., the received message at block 935 contains overhead information that was already forwarded to UE 515, etc.), then the communication with RAN 2 is not initiated at block 945 and the process instead advances to 1010 of FIG. 10.

At block 950, the paging hub 400 optionally stops (or suspends) monitoring one or more downlink wireless channel(s) that are specific to RAN 2 from the set of downlink wireless channels based on UE 515 entering into an active communication state by initiating the communication with RAN 2 (e.g., in response to a notification from UE 515 that UE 515 is initiating the communication with RAN 2). For example, in conjunction with establishing communication with RAN 2 at block 945, UE 515 will enter the active communication state in which UE 515 communicates with RAN 2 over either a shared channel (e.g., RACH, FACH, etc.) or a dedicated channel (e.g., TCH, dedicated bearer, etc.). In at least one embodiment, when UE 515 is operating in the active communication state with respect to RAN 2, RAN 2 can transmit data to UE 515 over the shared or dedicated channel instead of the one or more downlink wireless channel(s) on RAN 2 being monitored by the paging hub 400. In an alternative embodiment, the paging hub 400 can continue to monitor the downlink signal channel(s) that are specific to RAN 2 from the set of downlink wireless channels even though no signaling messages targeted to UE 515 are expected to be transmitted over these particular channel(s) while UE 515 remains in the active communication state with RAN 2.

While not shown expressly in FIG. 9, UE 515 may take one or more additional actions based on the received message from block 935 (e.g., updating communication parameters for RAN 2 based upon SIB and/or other overhead information contained in the received message from block 935). Also, while not shown expressly in FIG. 9, these one or more additional actions may be performed even if UE 515 determines not to initiate communication with RAN 2 at block 940.

FIG. 10 illustrates a continuation of the process of FIG. 9 in accordance with an embodiment of the disclosure. In particular, the process of FIG. 10 illustrates examples of different signaling message types that can be transmitted by the respective RANs 1 and 2 and different message forwarding rules that can be implemented at the paging hub 400.

At block 1000, the communication initiated at block 945 ends, and UE 515 exits the active communication state and once more refrains from monitoring any downlink wireless channel(s) used by RAN 2 (e.g., both the shared or dedicated channel used to support the communication with RAN 2 as well as any signaling channel(s) associated with the message forwarding service). At block 1005, if optional block 950 is performed whereby the paging hub 400 stops monitoring one or more downlink wireless channel(s) that are specific to RAN 2 from the set of downlink wireless channels based on UE 515 entering into the active communication state with RAN 2, then the paging hub 400 resumes monitoring these channel(s) for the message forwarding service based on a determination that UE 515 has exited the active communication state with RAN 2 (e.g., in response to a notification from UE 515 indicating that the RAN 2 communication has ended).

At block 1010 of FIG. 10, RAN 2 transmits a paging message that is targeted (e.g., individually targeted or group targeted) to UE 515 on a given downlink wireless channel from the set of downlink wireless channels. Still referring to block 1010, the paging message fails to arrive at UE 515 because UE 515 is not monitoring the set of downlink wireless channels per block 1000, but the paging message is detected by the paging hub 400 based on the monitoring from block 925 of FIG. 9 or block 1005 of FIG. 10 (e.g., as in block 710 of FIG. 7). At block 1015, the paging hub 400 (e.g., based on evaluation of one or more message forwarding rules) forwards a message including paging information from the paging message detected at block 1010 to the local wireless network 510 (e.g., via the backhaul network 500B) for transmission to UE 515 (e.g., as in block 715 of FIG. 7), and the forwarded message is transmitted by the local wireless network 510 and received at UE 515 (e.g., as in block 810 of FIG. 8). At block 1020, UE 515 responds to the forwarded message (e.g., based on an evaluation as to whether the paging information in the forwarded message is sufficient to warrant communication with RAN 2, similar to block 940 and/or based on any of the factors described above with respect to Table 1) by initiating communication with RAN 2. While not shown in FIG. 10, the paging hub 400 may optionally stop and then resume RAN 2 monitoring after UE 515 eventually ends communication with RAN 2, similar to block 950 of FIG. 9 and block 1005 of FIG. 10.

At block 1025 of FIG. 10, RAN 2 transmits an overhead message (e.g., a SIB overhead message) that is targeted (e.g., broadcast) to UE 515 on a given downlink wireless channel from the set of downlink wireless channels. Still referring to block 1025, the overhead message fails to arrive at UE 515 because UE 515 is not monitoring the set of downlink wireless channels per block 1000, but the overhead message is detected by the paging hub 400 based on the monitoring from block 925 of FIG. 9 or block 1005 of FIG. 10 (e.g., as in block 710 of FIG. 7). At block 1030, the paging hub 400 (e.g., based on evaluation of one or more message forwarding rules) determines not to forward information from the overhead message detected at block 1025 to the local wireless network 510 (e.g., via the backhaul network 500B) for transmission to UE 515 (e.g., as in block 715 of FIG. 7). For example, the overhead message may include redundant information that was already forwarded to the paging hub 400, in which case the redundant information need not be forwarded to UE 515. In another example, UE 515 may configure the paging hub 400 with a message forwarding rule (e.g., a default message forwarding rule, a user or UE-defined message forwarding rule, etc.) that indicates not to forward overhead messages from RAN 2.

At block 1035 of FIG. 10, RAN 1 transmits an overhead message that is targeted (e.g., broadcast) to UE 515 on a given downlink wireless channel from the set of downlink wireless channels. Still referring to block 1035, the paging message fails to arrive at UE 515 because UE 515 is not monitoring the set of downlink wireless channels per block 1000, but the overhead message is detected by the paging hub 400 based on the monitoring from block 925 of FIG. 9 or block 1005 of FIG. 10 (e.g., as in block 710 of FIG. 7). At block 1040, the paging hub 400 (e.g., based on evaluation of one or more message forwarding rules) forwards a message including overhead information from the overhead message detected at block 1035 to the local wireless network 510 (e.g., via the backhaul network 500B) for transmission to UE 515 (e.g., as in block 715 of FIG. 7), and the forwarded message is transmitted by the local wireless network 510 and received at UE 515 (e.g., as in block 810 of FIG. 8). At block 1045, UE 515 determines not to respond to the forwarded message (e.g., based on an evaluation as to whether the overhead information in the forwarded message is sufficient to warrant communication with RAN 2, similar to block 940 and/or based on any of the factors described above with respect to Table 1) and thereby does not initiate communication with RAN 2.

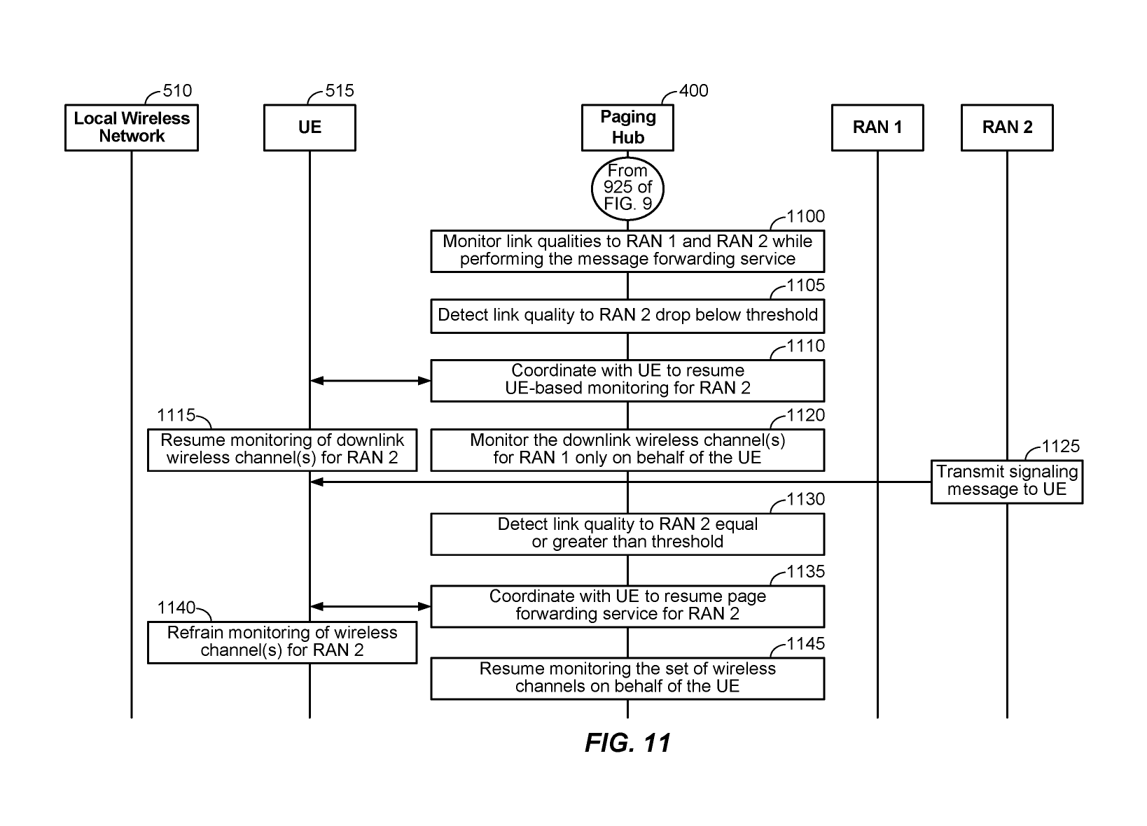

FIG. 11 illustrates a continuation of the process of FIG. 9 in accordance with another embodiment of the disclosure. In particular, the process of FIG. 11 illustrates how the message forwarding service can be selectively toggled on or off on a RAN-specific basis based on a link quality between the paging hub 400 and one or more RANs in accordance with at least one embodiment.

At block 1100, in conjunction with monitoring the set of downlink wireless channels used by RAN 1 and RAN 2 at block 925 of FIG. 9, the paging hub 400 also monitors link qualities to RAN 1 and RAN 2. In at least one embodiment, a measure of the link quality to a particular RAN can be based upon measurements made on one or more downlink wireless channels upon which that particular RAN is transmitting. In at least one embodiment, the measurements used to determine the link quality to the particular RAN can be performed on the same downlink wireless channels associated with the message forwarding service being monitored at block 925 of FIG. 9. In an alternative embodiment, the measurements used to determine the link quality to the particular RAN can be performed on at least one downlink wireless channel that is not associated with the message forwarding service being monitored at block 925 of FIG. 9, such as a pilot channel. In a further embodiment, the measurements used to determine the link quality to the particular RAN can include any well-known signal quality measurements, such as signal-to-noise ratio (SNR), signal-to-noise-plus-interference ratio (SINR), frame error rate (FER), Message Error Rate (MER) etc.

At block 1105, the paging hub 400 detects that the link quality for RAN 2 has dropped below a threshold. At block 1110, the paging hub 400 coordinates with UE 515 to resume UE-based monitoring for RAN 2. Accordingly, at block 1115, UE 515 resumes monitoring one or more downlink wireless channels used by RAN 2, and at block 1120, the paging hub 400 continues to monitor the downlink wireless channel(s) from the set of downlink wireless channel(s) for RAN 1 only on behalf of UE 515 for the message forwarding service. In other words, the paging hub-based monitoring of the one or more downlink wireless channels used by RAN 1 is suspended at block 1120. At block 1125, RAN 2 transmits a signaling message that is targeted (e.g., individually targeted, group targeted, or broadcast) to UE 515 on a given downlink wireless channel from the set of downlink wireless channels. The signaling message transmitted at block 1125 successfully arrives at UE 515 because UE 515 resumes monitoring the given downlink wireless channel at block 1115. While not shown expressly in FIG. 11, in at least one embodiment, any signaling messages targeted (e.g., individually targeted, group targeted, or broadcast) to UE 515 by RAN 1 would still be selectively forwarded to UE 515 via the local wireless network 510 in accordance with the message forwarding service irrespective of monitoring operations for RAN 2 being suspended.

At block 1130, the paging hub 400 detects that the link quality for RAN 2 is no longer below the threshold based upon the monitoring that begin at block 1100. At block 1135, the paging hub 400 coordinates with UE 515 to suspend UE-based monitoring for RAN 2 in response to the detection at block 1130. Accordingly, at block 1140, UE 515 refrains from the monitoring one or more downlink wireless channels used by RAN 2, and at block 1145, the paging hub 400 monitors the set of downlink wireless channel(s) for RANs 1 and 2 on behalf of UE 515 for the message forwarding service.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences, and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps, and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

1. A method of operating a paging hub, comprising:
registering a user equipment (UE) to a message forwarding service that is configured to forward information from messages wirelessly transmitted by two or more radio access networks (RANs) associated with different radio access technology (RAT)-types to the UE over a local wireless network that is separate from the two or more RANs;
monitoring a set of downlink wireless channels used by the two or more RANs;
detecting a signaling message that is transmitted over a given downlink wireless channel from the set of downlink wireless channels that is targeted to the UE; and
forwarding a message including information derived from the signaling message to the local wireless network for transmission to the UE.

2. The method of claim 1, wherein the registering includes:
identifying a set of RANs configured to communicate in accordance with a corresponding set of RAT-types for which monitoring is requested by the UE;
determining, for each RAT-type in the set of RAT-types, whether the paging hub supports the RAT-type; and
registering the UE to the message forwarding service in association with each RAN from the set of RANs that is configured to communicate in accordance with a supported RAT-type based on the determining.

3. The method of claim 2, wherein the determining is based upon Public Land Mobile Network (PLMN) details for the two or more RANs received from the UE during the registering.

4. The method of claim 1,
wherein the registering includes receiving UE-identifying information through which the two or more RANs identify the UE in downlink messaging, and
wherein the monitoring includes evaluating signaling messages transmitted on the set of downlink wireless channels for any signaling messages targeted to the UE-identifying information.

5. The method of claim 4, wherein the UE-identifying information includes two or more Temporary Mobile Subscriber Identity (TMSIs) assigned to the UE by the two or more RANs and/or an International Mobile Subscriber Identity (IMSI) of the UE.

6. The method of claim 1,
wherein the registering includes receiving group-identifying information through which the two or more RANs identify at least one group to which the UE belongs in downlink messaging, and the monitoring includes evaluating signaling messages transmitted on the set of downlink wireless channels for any signaling messages targeted to the group-identifying information, and/or
wherein the monitoring includes evaluating signaling messages transmitted on the set of downlink wireless channels for any broadcast messages.

7. The method of claim 1, further comprising:
determining to forward the message based upon an evaluation of one or more message forwarding rules,
wherein the forwarding is performed in response to the determining.

8. The method of claim 7, further comprising:
detecting another signaling message on the given downlink wireless channel or a different downlink wireless channel that is targeted to the UE; and
determining not to forward the message based upon another evaluation of the one or more message forwarding rules.

9. The method of claim 7, wherein the one or more message forwarding rules are based upon one or more of a signaling message type, a RAT-type of a given RAN from which the signaling message is transmitted and/or whether information redundant to the signaling message was previously forwarded to the UE.

10. The method of claim 1, wherein the local wireless network is a WiFi network or a device-to-device (D2D) cluster.

11. The method of claim 1, wherein the forwarding includes:
transmitting the message to a backhaul network for delivery to the local wireless network,
transmitting the message to an access point of the local wireless network,
transmitting the message to another device on the local wireless network that is wirelessly connected to the UE via one or more hops, or
transmitting the message to the UE via a direct wireless transmission.

12. The method of claim 1, further comprising:
determining that the UE has entered into an active communication state with a given RAN from the two or more RANs; and
suspending the monitoring for one or more downlink wireless channels from the set of downlink wireless channels that are used by the given RAN in response to the determining.

13. The method of claim 12, further comprising:
determining that the UE has exited the active communication state with the given RAN; and
resuming the monitoring for the one or more downlink wireless channels from the set of downlink wireless channels that are used by the given RAN in response to the determination that the UE has exited the active communication state with the given RAN.

14. The method of claim 1, wherein the monitoring continues irrespective of whether the UE enters into an active communication state with a given RAN from the two or more RANs.

15. The method of claim 1, further comprising:
monitoring link qualities associated with the two or more RANs;
detecting that a given link quality to a given RAN drops below a threshold based on the link quality monitoring;
coordinating with the UE to resume UE-based monitoring for one or more downlink wireless channels from the set of downlink wireless channels that are used by the given RAN in response to the link quality detection; and
suspending the monitoring for the one or more downlink wireless channels in response to the link quality detection.

16. The method of claim 15, further comprising:
detecting that the given link quality to the given RAN is no longer below the threshold based on the link quality monitoring;
coordinating with the UE to suspend the UE-based monitoring for the one or more downlink wireless channels in response to the link quality detection that the given link quality to the given RAN is no longer below the threshold; and
resuming the monitoring for the one or more downlink wireless channels in response to the link quality detection that the given link quality to the given RAN is no longer below the threshold.

17. The method of claim 1, wherein the signaling message corresponds to a paging message or an overhead message.

18. A method of operating a user equipment (UE), comprising:
registering, with a paging hub, to a message forwarding service that is configured to forward information from messages wirelessly transmitted by two or more radio access networks (RANs) associated with different radio access technology (RAT)-types to the UE over a local wireless network that is separate from the two or more RANs;
refraining from monitoring a set of downlink wireless channels used by the two or more RANs;
receiving, from the paging hub via the local wireless network, a message that is directed to the UE and which includes information derived from a signaling message that originated as a wireless transmission from a given RAN among the two or more RANs on a given downlink wireless channel among the set of downlink wireless channels; and
selectively communicating with the given RAN in response to the received message.

19. The method of claim 18, wherein the registering includes conveying, to the paging hub, UE-identifying information through which the two or more RANs identify the UE in downlink messaging and/or group-identifying information through which the two or more RANs identify at least one group UE to which the UE belongs in downlink messaging.

20. The method of claim 19, wherein the UE-identifying information includes two or more Temporary Mobile Subscriber Identity (TMSIs) assigned to the UE by the two or more RANs and/or an International Mobile Subscriber Identity (IMSI) of the UE.

21. The method of claim 18, wherein the registering includes conveying, to the paging hub, Public Land Mobile Network (PLMN) details for the two or more RANs received from the UE during the registering.

22. The method of claim 18, wherein the selectively communicating determines whether or not to communicate with the given RAN based at least in part up on a message type of the signaling message.

23. The method of claim 22,
wherein the selectively communicating communicates with the given RAN based at least in part upon the message type of the signaling message being a paging message, or
wherein the selectively communicating does not communicate with the given RAN based at least in part upon the message type of the signaling message being an overhead message.

24. The method of claim 18, wherein the local wireless network is a WiFi network or a device-to-device (D2D) cluster.

25. The method of claim 18,
wherein the selectively communicating communicates with the given RAN in response to the received message by entering into an active communication state with the given RAN, further comprising:
notifying the paging hub that the UE has entered into the active communication state with the given RAN to permit the paging hub to suspend monitoring of one or more downlink wireless channels from the set of downlink wireless channels that are used by the given RAN.

26. The method of claim 18, further comprising:
coordinating with the UE to resume UE-based monitoring for one or more downlink wireless channels from the set of downlink wireless channels that are used by the given RAN in response to a detection that a given link quality between the paging hub and the given RAN drops below a threshold.

27. The method of claim 26, further comprising:
coordinating with the UE to suspend the UE-based monitoring for the one or more downlink wireless channels in response to a subsequent detection that the given link quality between the paging hub and the given RAN is no longer below the threshold.

28. The method of claim 18,
wherein the signaling message is individually targeted to the UE based upon UE-identifying information through which the two or more RANs identify the UE in downlink messaging, or
wherein the signaling message is group targeted to the UE based upon group-identifying information through which the two or more RANs identify at least one group UE to which the UE belongs in downlink messaging, or
wherein the signaling message is a broadcast message.

29. A paging hub, comprising:
a processor, memory and transceiver circuitry configured to:
register a user equipment (UE) to a message forwarding service that is configured to forward information from messages wirelessly transmitted by two or more radio access networks (RANs) associated with different radio access technology (RAT)-types to the UE over a local wireless network that is separate from the two or more RANs;
monitor a set of downlink wireless channels used by the two or more RANs;
detect a signaling message that is transmitted over a given downlink wireless channel from the set of downlink wireless channels that is targeted to the UE; and
forward a message including information derived from the signaling message to the local wireless network for transmission to the UE.

30. A user equipment (UE), comprising:
a processor, memory and transceiver circuitry configured to:
register, with a paging hub, to a message forwarding service that is configured to forward information from messages wirelessly transmitted by two or more radio access networks (RANs) associated with different radio access technology (RAT)-types to the UE over a local wireless network that is separate from the two or more RANs;
refrain from monitoring a set of downlink wireless channels used by the two or more RANs;
receive, from the paging hub via the local wireless network, a message that is directed to the UE and which includes information derived from a signaling message that originated as a wireless transmission from a given RAN among the two or more RANs on a given downlink wireless channel among the set of downlink wireless channels; and
selectively communicate with the given RAN in response to the received message.
